(19) United States
(12) Patent Application Publication
(10) Pub. No.: US 2023/0318288 A1
(43) Pub. Date: Oct. 5, 2023

(54) SURGE PROTECTIVE DEVICE

(71) Applicant: Sichuan Zhongguang Lightning Protection Technologies Co., Ltd., Chengdu (CN)

(72) Inventors: Dezhi DAI, Chengdu (CN); Chengyong LEI, Chengdu (CN); Guohua YANG, Chengdu (CN); Xueying WANG, Chengdu (CN)

(73) Assignee: Sichuan Zhongguang Lightning Protection Technologies Co., Ltd., Chengdu (CN)

(21) Appl. No.: 17/707,987

(22) Filed: Mar. 30, 2022

(51) Int. Cl. H02H 9/06; H02H 9/04

(52) U.S. Cl. CPC H02H 9/06; H02H 9/044

(57) ABSTRACT

A surge protective device includes a first electrode terminal and a second electrode terminal; n gap units, connected in series between the first electrode terminal and the second electrode terminal sequentially, where a common terminal is formed between adjacent gap units; k first trigger circuits, the k first trigger circuits each include a first terminal connected to one of the common terminals, and a second terminal connected to the second electrode terminal; and m second trigger circuits, the m second trigger circuits each include a first terminal connected to one of the common terminals, and a second terminal connected to the first electrode terminal, where any one of the common terminals is connected only to either the first terminal of one of the first trigger circuits or the first terminal of one of the second trigger circuits.

### TECHNICAL FIELD

The present invention relates to the technical field of electrical protective devices, and in particular, relates to a surge protective device.

### BACKGROUND

Surge protective devices can be used to protect against surges caused by lightning effects and the likes. The surge protective device is arranged in a protected system. When a surge occurs on a line in the system, the surge protective device acts to limit the transient overvoltage on the line and discharge the surge current, so as to protect various electronic and electrical equipment in the system.

A working process of the existing gap-type surge protective device is to trigger gaps stacked in series layer by layer. A greater number of gap layers indicates a greater impact on the starting voltage and the voltage protection level. The trigger voltage of the entire gap-type surge protective device is the superimposed voltage after all the gaps are triggered, so the existing multi-layer gap-type surge protective device has relatively high starting voltage, which is difficult to reduce effectively. Under the condition of considering the safety and the ability to interrupt the follow current, it is extremely difficult to reduce the voltage protection level to less than 1,500 V, and the application is limited.

### SUMMARY

The technical problem to be solved and the technical task provided by the present invention are to improve the prior art and provide a surge protective device, which can solve the problem that it is difficult for the multi-layer gap-type surge protective device in the prior art to meet the development needs due to high starting voltage and poor protection effect under the condition of meeting high ability to interrupt the follow current.

To solve the above technical problems, the technical solution adopted by the present invention is as follows:

A surge protective device includes:

a first electrode terminal and a second electrode terminal;

n gap units, the n gap units are connected in series between the first electrode terminal and the second electrode terminal sequentially, where a common terminal is formed between adjacent gap units;

k first trigger circuits, the k first trigger circuits each include a first terminal connected to one of the common terminals, and a second terminal connected to the second electrode terminal; and

m second trigger circuits, the m second trigger circuits each include a first terminal connected to one of the common terminals, and a second terminal connected to the first electrode terminal, where

any one of the common terminals is connected only to either the first terminal of one of the first trigger circuits or the first terminal of one of the second trigger circuits; and

n≥3, 1≤k<n−1, and 1≤m<n−1, where n, k, and m are integers.

The surge protective device of the present invention uses the second trigger circuits to trigger the gap units in advance, which is equivalent to shortening the stacking quantity of the gap units. When a surge voltage is applied to the first electrode terminal and the second electrode terminal, the surge voltage first acts on a series circuit formed by the first path of the first trigger circuit and the first gap unit adjacent to the first electrode terminal, and then the first gap unit discharges, such that electrical continuity is established at both terminals of the first gap unit. Similarly, the gap units are triggered one by one from the first electrode terminal to the second electrode terminal. Due to the existence of the second trigger circuits, one-way one-by-one triggering method is broken. The second trigger circuits, the gap units on both sides of the common terminal connected to the second trigger circuits, and the first trigger circuit connected to the two gap units also constitute the shortest series circuit between the first electrode terminal and the second electrode terminal. That is, the surge voltage will also be applied to the series circuit at the first time, such that the gap units on both sides of the common terminal connected to the second trigger circuits will be triggered to discharge in advance to establish electrical continuity, and then triggering will be performed layer by layer from the common terminal connected to the second trigger circuits towards the first electrode terminal and the second electrode terminal respectively. That is, the number of layers for layer-by-layer triggering is shortened, the cardinality of the starting of the next gap unit affected by the impedance after the triggering of the last gap unit is reduced, the front-of-wave sparkover voltage is effectively reduced, the starting voltage is reduced, the response speed is improved, and the protection performance of the surge protective device is improved.

Further, when only one second trigger circuit may be arranged, the first terminal of the second trigger circuit may be connected to a t-th common terminal counted from the first electrode terminal to the second electrode terminal, 2≤t≤n−1, where t is an integer; or, the first terminals of the k first trigger circuits may be respectively connected to the first k common terminals counted from the first electrode terminal to the second electrode terminal, the first terminals of the m second trigger circuits may be respectively connected to the t-th to (n−1)-th common terminals counted from the first electrode terminal to the second electrode terminal, and t=k+1, such that the (k+1)-th to n-th gap units counted from the first electrode terminal to the second electrode terminal can be triggered more quickly and stably, effectively shortening the total response time of the entire surge protective device, and improving the performance of the surge protective device.

Further, if a number n of the gap units is 16 to 22, n−7≤t≤n−4.

If the number n of the gap units is 13 to 15, n−6≤t≤n−2.

If the number n of the gap units is 8 to 12, n−5≤t≤n−2.

If the number n of the gap units is 4 to 7, n−2≤t≤n−1.

If the number n of the gap units is 3, t=2.

The position of the common terminal connected to the second trigger circuits has an impact on reducing the starting voltage and improving the response speed. Between the t-th common terminal and the first electrode terminal, two layer-by-layer triggering processes are performed in the opposite direction at the same time, while between the t-th common terminal and the second electrode terminal, a single layer-by-layer triggering process is performed. That is, triggering between the t-th common terminal and the second electrode terminal is relatively slow, so the common terminal connected to the second trigger circuits needs to be in a suitable position to ensure that the gap unit between the common terminal connected to the second trigger circuits and the second electrode terminal can be quickly triggered, thereby reducing the front-of-wave sparkover voltage.

Further, each of the first trigger circuits and the second trigger circuits may include a capacitor, and a capacity of the capacitor in each of the second trigger circuits may be greater than or equal to a capacity of the capacitor in each of the first trigger circuits. When the second trigger circuits are used to trigger the gap units on both sides of the t-th common terminal, the capacitor of each of the second trigger circuits will be charged. If the charging voltage of the second trigger circuits is too high, the voltage of the t-th common terminal after the gap unit discharges to establish electrical continuity is low, which affects the triggering of the next pair of gap units. The capacity of the capacitor is related to the charging voltage. The charging voltage is reduced by increasing the capacity of the capacitor, thereby ensuring better triggering of the subsequent gap units.

Further, the first trigger circuit connected to an i-th common terminal is CXi, 1≤i≤t−1, where i is an integer, and a capacity of the capacitor in CXi may be greater than or equal to a capacity of the capacitor in each of the other first trigger circuits. The use of CXi enhances the current after the triggering of the gap units between the first electrode terminal and the i-th common terminal, and also enhances the current after the triggering of the gap units between the i-th common terminal and the t-th common terminal. The conductivity is improved, and the current to maintain the conduction of the gap unit is improved, thereby reducing the arc voltage of the gap unit, and reducing the total front-of-wave sparkover voltage.

Further, if a number n of the gap units is 16 to 22, 5≤t−i≤10, that is, the common terminal connected to CXi and the common terminal connected to the second trigger circuit are separated by 5 to 10 gap units.

If the number n of the gap units is 13 to 15, 4≤t−i≤9, that is, the common terminal connected to CXi and the common terminal connected to the second trigger circuit are separated by 4 to 9 gap units.

If the number n of the gap units is 8 to 12, 3≤t−i≤6, that is, the common terminal connected to CXi and the common terminal connected to the second trigger circuit are separated by 3 to 6 gap units.

If the number n of the gap units is 4 to 7, 2≤t−i≤3, that is, the common terminal connected to CXi and the common terminal connected to the second trigger circuit are separated by 2 to 3 gap units.

If the number n of the gap units is 3, t−i=1, that is, the common terminal connected to CXi and the common terminal connected to the second trigger circuit are separated by 1 gap unit.

The position of the common terminal connected to CXi is related to the position of the t-th common terminal connected to the second trigger circuits, and is also related to the total number of the gap units. The above method ensures that the gap units between the first electrode terminal and the t-th common terminal can be quickly triggered and conducted, which improves the response speed, and reduces the total front-of-wave sparkover voltage.

Further, a spark gap spacing of each of 2nd to i-th gap units counted from the first electrode terminal to the second electrode terminal may be less than a spark gap spacing of each of the other gap units. Under the same conditions, a smaller spark gap spacing indicates a smaller breakdown voltage required. The above method can reduce the voltage fluctuation when the gap unit is triggered, such that the final trigger waveform is more stable, thereby reducing the fluctuation of the total front-of-wave sparkover voltage.

Further, a spark gap spacing of a first gap unit adjacent to the first electrode terminal may be greater than or equal to a spark gap spacing of each of the other gap units. A smaller spark gap spacing indicates a smaller breakdown voltage required. Setting the spark gap spacing of the first gap unit to be greater than the spark gap spacing of each of the other gap units can improve the resistance of the surge protective device and reduce the leakage current, and can improve the forward conduction performance.

Further, the first terminals of the first trigger circuits and the first terminals of the second trigger circuits may be connected to n−1 common terminals sequentially and alternately from the first electrode terminal to the second electrode terminal, which is equivalent to dividing the gap units in series into several sections, making the triggering more rapid and stable, and shortening the total response time of the entire surge protective device.

Further, a voltage limiting circuit may be further connected between the first electrode terminal and the second electrode terminal, and the voltage limiting circuit may be composed of a voltage limiting element or a combination of a voltage limiting element and a switching element. The voltage limiting circuit is used to limit the excessive voltage, and suppress the peak waveform occurring during the breakdown of the spark gaps, so as to ensure that the residual voltage is within a low range, which can shorten the response time of the multi-layer gap-type surge protective device.

Further, each of the first trigger circuits and the second trigger circuits may be composed of one of or a combination of at least two of capacitors, resistors, varistors, inductors, thermistors, transient suppression diodes, air gaps, and gas discharge tubes (GDTs).

Further, the gap units may each include one of or a combination of at least two of GDTs, gaps formed by graphite electrodes, and gaps formed by metal electrodes, or the gap units may each include a combination of the GDTs, the gaps formed by the graphite electrodes, the gaps formed by the metal electrodes with at least one of capacitors, resistors, varistors, inductors, and thermistors.

A surge protective device includes:

a first electrode terminal and a second electrode terminal;

n gap units, the n gap units are connected in series between the first electrode terminal and the second electrode terminal sequentially, where a common terminal is formed between adjacent gap units;

k first trigger circuits, the k first trigger circuits each include a first terminal connected to one of the common terminals, and a second terminal connected to the second electrode terminal; and

m second trigger circuits, the m second trigger circuits each include a first terminal connected to one of the common terminals, and a second terminal connected to the first electrode terminal, where

n≥2, 1≤k≤n−1, and 1≤m≤n−1, where n, k, and m are integers.

A surge protective device includes:

a first electrode terminal and a second electrode terminal;

n gap units, the n gap units are connected in series between the first electrode terminal and the second electrode terminal sequentially, where a common terminal is formed between adjacent gap units;

k first trigger circuits, the k first trigger circuits each include a first terminal connected to one of the common terminals, and a second terminal connected to the second electrode terminal; and

m second trigger circuits, the m second trigger circuits each include a first terminal connected to one of the common terminals, and a second terminal connected to one of the common terminals or connected to a same common terminal, where

n≥2, 1≤k≤n−1, and 1≤m≤n−1, where n, k, and m are integers.

Compared with the prior art, the present invention has the following advantages:

The surge protective device of the present invention uses the second trigger circuits to trigger the gap units in advance, shortening the stacking quantity of the gap units triggered layer by layer, reducing the cardinality of the starting of the next gap unit affected by the impedance after the triggering of the last gap unit, effectively reducing the front-of-wave sparkover voltage, reducing the starting voltage, improving the response speed, and improving the protection performance of the surge protective device.

### BRIEF DESCRIPTION OF THE DRAWINGS

FIG. 1 is a schematic circuit diagram of Embodiment I;

FIGS. 2A-2N show different types of trigger circuits;

FIGS. 3A-3P show different types of gap units;

FIG. 4 is a schematic circuit diagram of Embodiment II;

FIG. 5 is a schematic circuit diagram of Embodiment III;

FIG. 6 is a schematic circuit diagram of Embodiment IV;

FIG. 7 is a schematic circuit diagram of Embodiment V;

FIG. 8 is a schematic circuit diagram of Embodiment VI;

FIG. 9 is a first schematic circuit diagram of Embodiment VII;

FIG. 10 is a second schematic circuit diagram of Embodiment VII;

FIG. 11 is a schematic diagram of a specific circuit of the prior art; and

FIG. 12 is a circuit diagram I of a specific implementation of the present invention.

In the figures: a first electrode terminal is denoted by A; a second electrode terminal is denoted by B; gap units are denoted by F1, F2, . . . , and Fn; first trigger circuits are denoted by CX1, CX2, . . . , and CXk; and second trigger circuits are denoted by CY1, CY2, . . . , and CYm.

### DETAILED DESCRIPTION OF THE EMBODIMENTS

The technical solutions in the embodiments of the present invention will be described below clearly and completely with reference to the accompanying drawings in the embodiments of the present invention. Apparently, the described embodiments are merely some rather than all of the embodiments of the present invention. All other embodiments obtained by those of ordinary skill in the art based on the embodiments of the present invention without creative efforts shall fall within the protection scope of the present invention.

The surge protective device provided by the embodiment of the present invention effectively improves the trigger circuit, shortens the number of layers for layer-by-layer triggering, effectively reduces the starting voltage, reduces the front-of-wave sparkover voltage, improves the response speed, and increases the application scope of the surge protective device.

### Embodiment I

A surge protective device includes: a first electrode terminal A and a second electrode terminal B; n gap units; and k first trigger circuits.

The first electrode terminal A and the second electrode terminal B are provided.

The n gap units are connected in series between the first electrode terminal A and the second electrode terminal B sequentially. A common terminal is provided between adjacent gap units.

First terminals of the k first trigger circuits are respectively connected to one common terminal, and second terminals of the k first trigger circuits are all connected to the second electrode terminal B.

The surge protective device further includes m second trigger circuits, first terminals of the m second trigger circuits are respectively connected to one common terminal, and second terminals of the m second trigger circuits are all connected to the first electrode terminal A.

A single common terminal is connected only to either the first terminal of one of the first trigger circuits or the first terminal of one of the second trigger circuits.

n≥3, 1≤k≤n−1, and 1≤m<n−1, where n, k, and m are integers. When a single common terminal is connected only to either the first trigger circuit or the second trigger circuit, k+m=n−1.

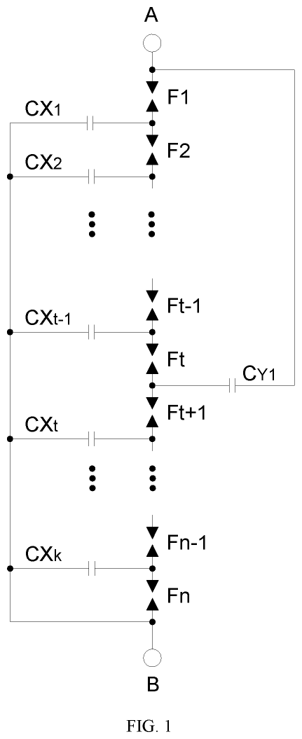

Specifically, as shown in FIG. 1, when only one second trigger circuit is arranged, the first terminal of the second trigger circuit is connected to a t-th common terminal counted from the first electrode terminal A to the second electrode terminal B, 2≤t≤n−1, where t is an integer, then the number of the first trigger circuits is k=n−2.

Counted from the first electrode terminal A to the second electrode terminal B, the gap units are F1, F2, . . . , and Fn sequentially, the first trigger circuits are CX1, CX2, . . . , and CXk sequentially, the second trigger circuit is CY1, and CY1 is connected to the t-th common terminal.

When a surge voltage is applied to the first electrode terminal and the second electrode terminal, CX1 triggers F1. After F1 discharges and is conducted to establish electrical continuity, CX2 triggers F2, that is, through the first trigger circuits, the gap units are triggered from F1 towards Fn sequentially. Due to the existence of the second trigger circuits, CY1, Ft, and CXt−1 constitute the shortest series circuit between the first electrode terminal and the second electrode terminal, and at the same time, CY1, Ft+1, and CXt+1 also constitute the shortest series circuit between the first electrode terminal and the second electrode terminal, such that while CX1 triggers F1, CY1 triggers Ft and Ft+1 at both ends of the t-th common terminal, Ft and Ft+1 discharge and are conducted to establish electrical continuity, and then triggering will be performed layer by layer towards the first working electrode and the second working electrode. The next group to be triggered is Ft−1 and Ft+2, which is equivalent to shortening the number of layers for layer-by-layer triggering, thereby reducing the cardinality of the starting of the next gap affected by the impedance after the triggering of the last gap, reducing the front-of-wave sparkover voltage, reducing the starting voltage, shortening the response time, and improving the performance of the surge protective device.

The position of the common terminal connected to the second trigger circuits has an impact on reducing the starting voltage and improving the response speed. It is necessary to ensure that the gap unit between the common terminal connected to the second trigger circuits and the second electrode terminal can be quickly triggered, thereby reducing the front-of-wave sparkover voltage. Therefore, the t-th common terminal connected to the second trigger circuits usually needs to be more adjacent to the second electrode terminal. Preferably, if a number n of the gap units is 16 to 22, n−7≤t≤n−4. If the number n of the gap units is 13 to 15, n−6≤t≤n−2. If the number n of the gap units is 8 to 12, n−5≤t≤n−2. If the number n of the gap units is 4 to 7, n−2≤t≤n−1. If the number n of the gap units is 3, t=2.

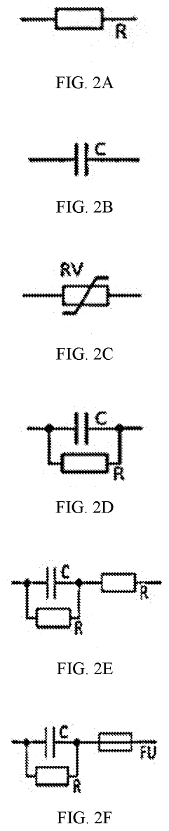

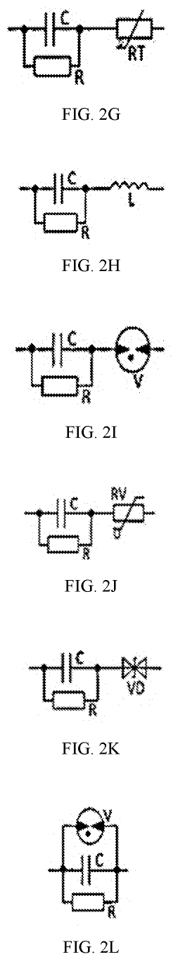

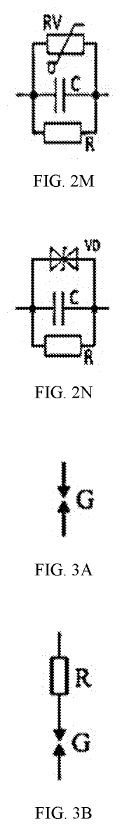

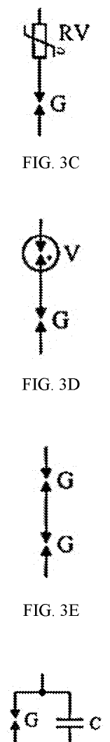

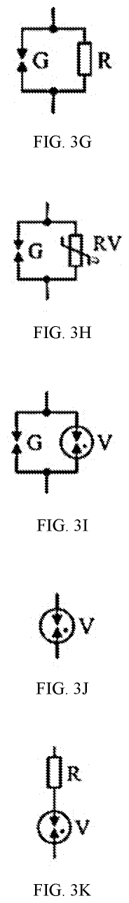

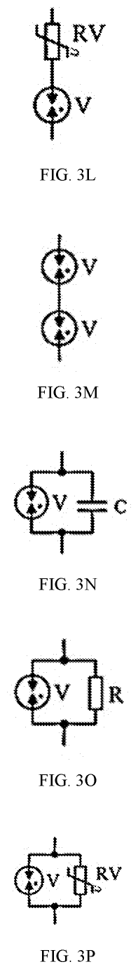

Each of the first trigger circuits and the second trigger circuits is composed of one of or a combination of at least two of capacitors, resistors, varistors, inductors, thermistors, transient suppression diodes, air gaps, and GDTs. Specifically, as shown in FIGS. 2A-2N, the trigger circuit may be any one of the trigger circuits shown in the figure. The gap units connected in series between the first electrode terminal A and the second electrode terminal B may be all the same, or some of them may be different. The gap units each include one of or a combination of at least two of GDTs, gaps formed by graphite electrodes, and gaps formed by metal electrodes, or the gap units each include a combination of the GDTs, the gaps formed by the graphite electrodes, the gaps formed by the metal electrodes with at least one of capacitors, resistors, varistors, inductors, and thermistors. Specifically, as shown in FIGS. 3A-3P, the gap unit may be any one of the sixteen gap units shown in the figure. FIG. 3A shows a two-electrode air gap G. FIG. 3B shows a two-electrode air gap G in series with a resistor R. FIG. 3C shows a two-electrode air gap G in series with a varistor RV. FIG. 3D shows a two-electrode air gap G in series with a GDT V. FIG. 3E shows a two-electrode air gap G in series with a two-electrode air gap G. FIG. 3F shows a two-electrode air gap G in parallel with a capacitor C. FIG. 3G shows a two-electrode air gap G in parallel with a resistor R. FIG. 3H shows a two-electrode air gap G in parallel with a varistor RV. FIG. 3I shows a two-electrode air gap G in parallel with a two-electrode GDT V. FIG. 3J shows a two-electrode GDT V. FIG. 3K shows a two-electrode GDT V in series with a resistor R. FIG. 3L shows a two-electrode GDT V in series with a varistor RV FIG. 3M shows a two-electrode GDT V in series with a two-electrode GDT V. FIG. 3N shows a two-electrode GDT V in parallel with a capacitor C. FIG. 3O shows a two-electrode GDT V in parallel with a resistor R. FIG. 3P shows a two-electrode GDT V in parallel with a varistor RV.

When each of the first trigger circuits and the second trigger circuits includes a capacitor, a capacity of the capacitor in each of the second trigger circuits is greater than or equal to a capacity of the capacitor in each of the first trigger circuits. Preferably, the capacity of the capacitor in the second trigger circuit is α times the capacity of the capacitor in the first trigger circuit, where 2≤α≤100, or α=n−t. When the second trigger circuit is used to trigger Ft and Ft+1 on both sides of the t-th common terminal, the capacitor of the second trigger circuit will be charged. If the charging voltage of the second trigger circuit is too high, the voltage of the t-th common terminal after the discharge of Ft and Ft+1 is low, which affects the triggering of Ft−1 and Ft+2. The capacity of the capacitor is related to the charging voltage. The charging voltage is reduced by increasing the capacity of the capacitor, thereby ensuring better triggering of the subsequent gap units.

In addition, a spark gap spacing of F1 can also be set to be greater than or equal to a spark gap spacing of each of the other gap units, which can improve the resistance of the surge protective device, reduce the leakage current, and improve the forward conduction performance.

### Embodiment II

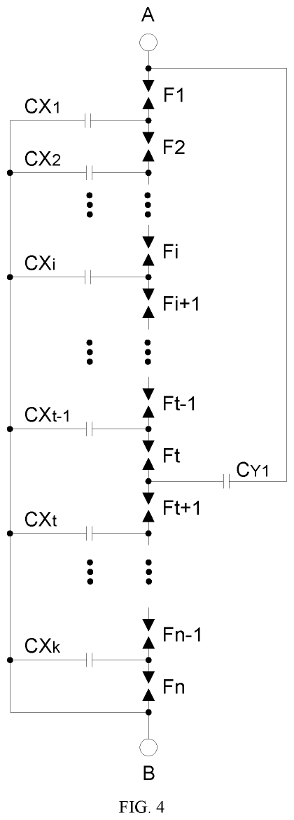

As shown in FIG. 4, on the basis of Embodiment I, the first trigger circuit connected to an i-th common terminal is CXi, 1≤i≤t−1, where i is an integer, and a capacity of the capacitor in CXi is greater than or equal to a capacity of the capacitor in each of the other first trigger circuits. Preferably, the capacity of the capacitor in CXi is 2 to 100 times the capacity of the capacitor in each of the other first trigger circuits, or the capacity of the capacitor in CXi is equal to the capacity of the capacitor in the second trigger circuit. The large capacity of the capacitor in CXi enhances the current after the triggering of the gap units between the first electrode terminal and the i-th common terminal and the current after the triggering of the gap units between the i-th common terminal and the t-th common terminal, such that the conductivity is improved, and the total front-of-wave sparkover voltage can be reduced.

A relationship between the position of the common terminal connected to CXi and the position of the t-th common terminal connected to the second trigger circuit has an impact on the trigger performance. Preferably, if a number n of the gap units is 16 to 22, 5≤t−i≤10. If the number n of the gap units is 13 to 15, 4≤t−i≤9. If the number n of the gap units is 8 to 12, 3≤t−i≤6. If the number n of the gap units is 4 to 7, 2≤t−i≤3. If the number n of the gap units is 3, t−i=1. It is ensured that the gap units between the first electrode terminal and the t-th common terminal can be quickly triggered and conducted, which improves the response speed, and reduces the total front-of-wave sparkover voltage.

Further, a spark gap spacing of each of 2nd to i-th gap units counted from the first electrode terminal A to the second electrode terminal B is less than or equal to a spark gap spacing of each of the other gap units. Preferably, the spark gap spacing of each of the 2nd to i-th gap units is 0.02-0.2 mm less than the spark gap spacing of each of the other gap units. In addition, the spark gap spacing of each of the gap units between the i-th common terminal and the t-th common terminal is greater than the spark gap spacing of each of the gap units between the t-th common terminal and the second electrode terminal B. The layer-by-layer triggering generated by the second trigger circuit includes two branch directions. In one branch direction, the layer-by-layer triggering is performed from the t-th common terminal to the first electrode terminal, and in the other branch direction, the layer-by-layer triggering is performed from the t-th common terminal to the second electric terminal. The above solution is used to ensure that the trigger conduction can be preferentially performed from the t-th common terminal to the second electrode terminal, which can make the circuit trigger more stable, suppress the peak waveform during the breakdown of the spark gaps, and make the trigger waveform more stable.

### Embodiment III

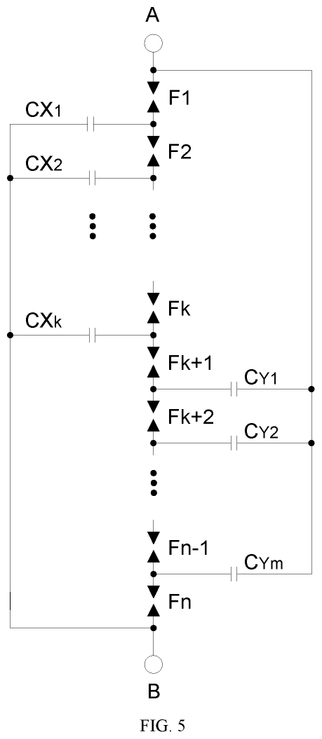

As shown in FIG. 5, the difference from Embodiment I is that multiple second trigger circuits are arranged. In the direction from the first electrode terminal A to the second electrode terminal B, the second trigger circuits are CY1, CY2, . . . , and CYm sequentially. The first terminals of the k first trigger circuits are respectively connected to the first k common terminals counted from the first electrode terminal A to the second electrode terminal B, that is, the k first trigger circuits are centrally connected to k common terminals adjacent to the first electrode terminal A, while the first terminals of the m second trigger circuits are respectively connected to the t-th to (n−1)-th common terminals counted from the first electrode terminal A to the second electrode terminal B, where t=k+1, that is, the m second trigger circuits are centrally connected to m common terminals adjacent to the second electrode terminal B, such that the m two second trigger circuits can trigger the gap units on the branch from Ft+1 to Fn more quickly and stably, shortening the total response time of the entire surge protective device.

### Embodiment IV

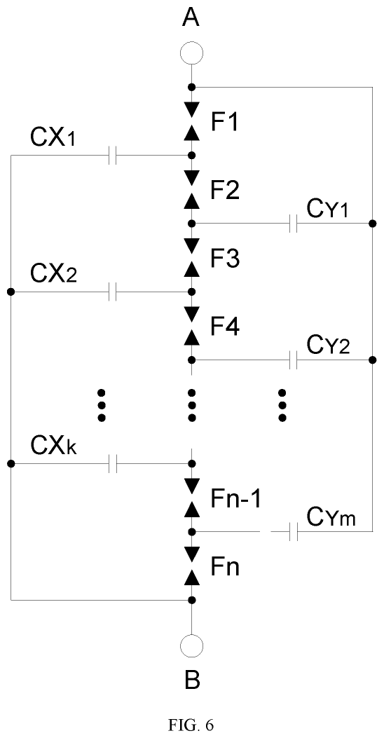

As shown in FIG. 6, the difference from Embodiment III is that the first terminals of the first trigger circuits and the first terminals of the second trigger circuits are connected to n−1 common terminals sequentially and alternately from the first electrode terminal A to the second electrode terminal B, which is equivalent to dividing the gap units in series into several sections, making the triggering more rapid and stable, and effectively shortening the total response time of the entire surge protective device.

### Embodiment V

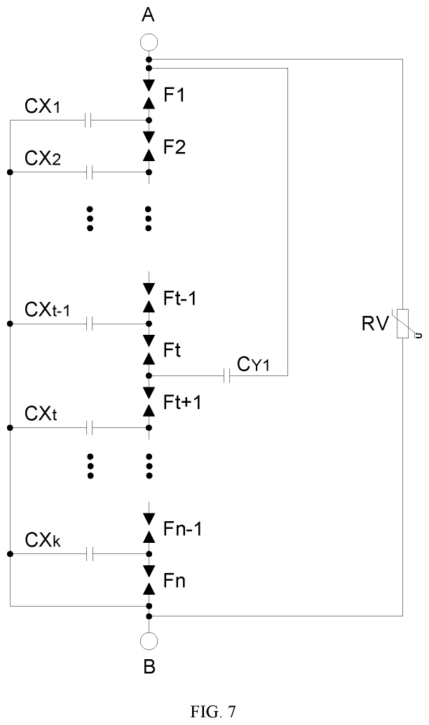

As shown in FIG. 7, on the basis of Embodiment I, a voltage limiting circuit is further connected between the first electrode terminal A and the second electrode terminal B, and the voltage limiting circuit is composed of a voltage limiting element or a combination of a voltage limiting element and a switching element. Specifically, the voltage limiting circuit may be a varistor or a combination of a varistor with lightning protection devices such as GDTs, gaps formed by graphite electrodes, or gaps formed by metal electrodes, capacitors, resistors, resistance capacitors, varistors, inductors, and thermistors. After the voltage limiting circuit is connected in parallel between the first electrode terminal A and the second electrode terminal B, the pressure-sensitive voltage limiting characteristics can be used to respond to surges greater than the pressure-sensitive voltage, and reduce the total response time of the entire surge protective device.

### Embodiment VI

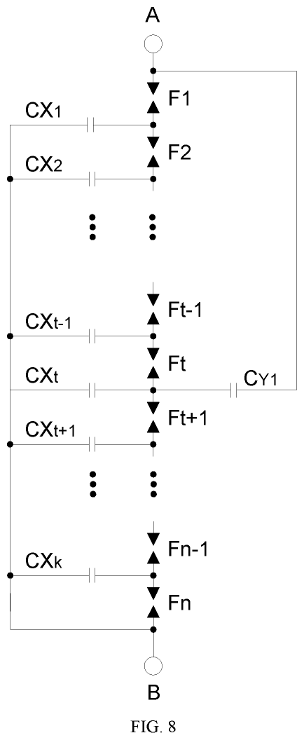

As shown in FIG. 8, a surge protective device includes: a first electrode terminal A and a second electrode terminal B; n gap units; and k first trigger circuits.

The first electrode terminal A and the second electrode terminal B are provided.

The n gap units are connected in series between the first electrode terminal A and the second electrode terminal B sequentially. A common terminal is provided between adjacent gap units.

First terminals of the k first trigger circuits are respectively connected to one common terminal, and second terminals of the k first trigger circuits are all connected to the second electrode terminal B.

The surge protective device further includes m second trigger circuits, first terminals of the m second trigger circuits are respectively connected to one common terminal, and second terminals of the m second trigger circuits are all connected to the first electrode terminal A. The common terminal can be connected to the first trigger circuit and the second trigger circuit at the same time.

n≥2, 1≤k≤n−1, and 1≤m≤n−1, where n, k, and m are integers.

Specifically, counting from the first electrode terminal A to the second electrode terminal B, the gap units are F1, F2, . . . , and Fn sequentially, the common terminals of adjacent gap units are A1, A2, . . . , and An−1 sequentially, k=n−1 first trigger circuit are arranged, which are CX1, CX2, . . . , and CXn−1 sequentially, one second trigger circuit is arranged, which is CY1, and CY1 is connected to the t-th common terminal, that is, the t-th common terminal is connected to the first trigger circuit and the second trigger circuit at the same time.

The working process of the above surge protective device is similar to that of Embodiment I. When a surge voltage is applied to the first electrode terminal and the second electrode terminal, CX1 triggers F1. After F1 discharges and is conducted to establish electrical continuity, CX2 triggers F2. Due to the existence of the second trigger circuits, CY1, Ft, and CXt−1 constitute the shortest series circuit between the first electrode terminal and the second electrode terminal, and at the same time, CY1, Ft+1, and CXt+1 also constitute the shortest series circuit between the first electrode terminal and the second electrode terminal, such that while CX1 triggers F1, CY1 triggers Ft and Ft+1 at both ends of the t-th common terminal, Ft and Ft+1 discharge and are conducted to establish electrical continuity, and then triggering will be performed layer by layer towards the first working electrode and the second working electrode. The next group to be triggered is Ft−1 and Ft+2, which is equivalent to shortening the number of layers for layer-by-layer triggering, thereby reducing the cardinality of the starting of the next gap affected by the impedance after the triggering of the last gap, reducing the front-of-wave sparkover voltage, reducing the starting voltage, and shortening the response time. Compared with Embodiment I, the effect of this solution is relatively weak.

### Embodiment VII

A surge protective device includes: a first electrode terminal A and a second electrode terminal B; n gap units; and k first trigger circuits.

The first electrode terminal A and the second electrode terminal B are provided.

The n gap units are connected in series between the first electrode terminal A and the second electrode terminal B sequentially. A common terminal is provided between adjacent gap units.

First terminals of the k first trigger circuits are respectively connected to one common terminal, and second terminals of the k first trigger circuits are all connected to the second electrode terminal B.

The surge protective device further includes m second trigger circuits, first terminals of the m second trigger circuits are respectively connected to one common terminal, and second terminals of the m second trigger circuits are respectively connected to one common terminal or connected to a same common terminal.

n≥2, 1≤k≤n−1, and 1≤m≤n−1, where n, k, and m are integers.

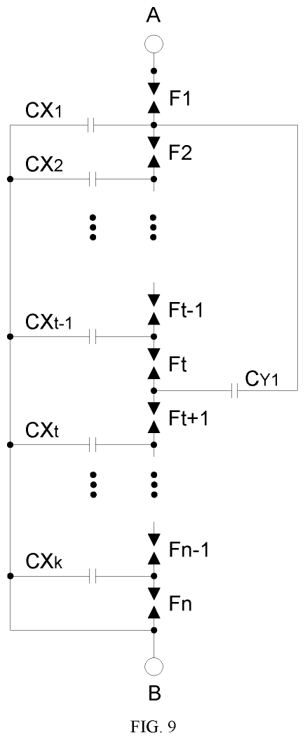

Specifically, as shown in FIG. 9, only one second trigger circuit is arranged, the first terminal of the second trigger circuit is connected to the t-th common terminal, the second terminal of the second trigger circuit is connected to the 1st common terminal, and only the second trigger circuit is connected to the t-th common terminal, while the first trigger circuit is not connected to the t-th common terminal. n−2 first trigger circuits are arranged from the 1st common terminal to the (n−1)-th common terminal (excluding the t-th common terminal). Each common terminal is respectively connected to a first trigger circuit.

The working process of the above surge protective device is similar to that of Embodiment I. When a surge voltage is applied to the first electrode terminal and the second electrode terminal, CX1 triggers F1. After F1 discharges and is conducted to establish electrical continuity, CX2 triggers F2, and through the first trigger circuits, the gap units are triggered from F1 towards Fn sequentially. Due to the existence of the second trigger circuits, after F1 discharges and is conducted to establish electrical continuity, the “conducted F1”, CY1, Ft, and CXt−1 constitute the shortest series circuit between the first electrode terminal and the second electrode terminal, and at the same time, the “conducted F1”, CY1, Ft+1, and CXt+1 also constitute the shortest series circuit between the first electrode terminal and the second electrode terminal, such that while CX2 triggers F2, CY1 triggers Ft and Ft+1 at both ends of the t-th common terminal, Ft and Ft+1 discharge and are conducted to establish electrical continuity, and then triggering will be performed layer by layer towards the first working electrode and the second working electrode. The next group to be triggered is Ft−1 and Ft+2, which is equivalent to shortening the number of layers for layer-by-layer triggering, thereby reducing the cardinality of the starting of the next gap affected by the impedance after the triggering of the last gap, reducing the front-of-wave sparkover voltage, reducing the starting voltage, and shortening the response time. Compared with Embodiment I, the response speed of this solution is slightly low.

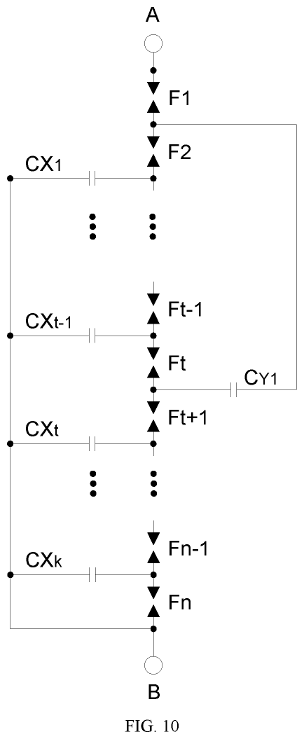

Specifically, as shown in FIG. 10, only one second trigger circuit is arranged, the first terminal of the second trigger circuit is connected to the t-th common terminal, the second terminal of the second trigger circuit is connected to the 1st common terminal, and only the second trigger circuit is connected to the t-th common terminal, while the first trigger circuit is not connected to the t-th common terminal. n−3 first trigger circuits are arranged from the 2nd common terminal to the (n−1)-th common terminal (excluding the t-th common terminal). Each common terminal is respectively connected to a first trigger circuit. The working process is similar to that of the previous solution.

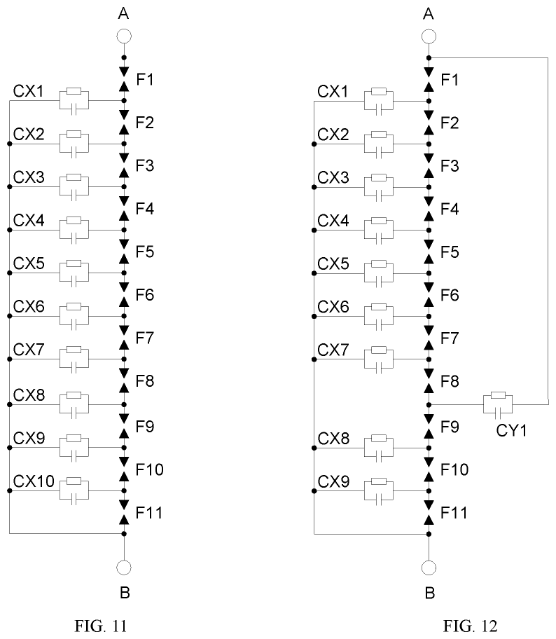

FIG. 11 shows a surge protective device in the prior art. F1-F11 are spark gaps, the capacity of the capacitor in the first trigger circuit CX1-CX10 is 1,000 pF, the starting voltage is 1,200 V, and the results of 10 front-of-wave sparkover voltage tests are as shown in Table 1.

TABLE 1
(unit: kV)

| 1 | 2 | 3 | 4 | 5 | 6 | 7 | 8 | 9 | 10 |
|---|---|---|---|---|---|---|---|---|---|
| 2.12 | 2.26 | 1.96 | 2.12 | 2.22 | 1.96 | 2.36 | 2.06 | 2.00 | 2.22 |

As shown in FIG. 12, F1-F11 are spark gaps, the capacity of the capacitor in the first trigger circuit CX1-CX9 is 1,000 pF, the capacity of the capacitor in the second trigger circuit CY1 is 5 nF, the capacity of the capacitor in CX5 is 7 nF, the starting voltage is 700 V, and the results of 10 front-of-wave sparkover voltage tests are shown in Table 2.

TABLE 2
(unit: kV)

| 1 | 2 | 3 | 4 | 5 | 6 | 7 | 8 | 9 | 10 |
|---|---|---|---|---|---|---|---|---|---|
| 1.14 | 1.32 | 1.20 | 1.16 | 1.04 | 1.22 | 1.12 | 1.10 | 1.20 | 1.26 |

The above described are merely preferred implementations of the present invention. It should be pointed out that the preferred implementations should not be construed as a limitation to the present invention, and the protection scope of the present invention should be subject to the claims of the present invention. Those of ordinary skill in the art may make several improvements and modifications without departing from the spirit and scope of the present invention, but the improvements and modifications should fall within the protection scope of the present invention.

What is claimed is:

1. A surge protective device, comprising:
a first electrode terminal and a second electrode terminal;
n gap units, wherein the n gap units are connected in series between the first electrode terminal and the second electrode terminal sequentially, wherein a common terminal is formed between adjacent gap units of the n gap units;
k first trigger circuits, wherein the k first trigger circuits each comprise a first terminal connected to one of the common terminals, and a second terminal connected to the second electrode terminal; and
only one second trigger circuit, wherein the second trigger circuit comprises a first terminal connected to one of the common terminals, and a second terminal connected to the first electrode terminal, wherein
any one of the common terminals is connected only to either a first terminal of one of the k first trigger circuits or the first terminal of the second trigger circuit;
wherein n≥3, and 1≤k<n−1, wherein n, and k, are integers,
wherein each of the k first trigger circuits and the second trigger circuit comprises a capacitor, and a capacitance in the capacitor of the second trigger circuit is greater than a capacitance of each capacitor in each of the k first trigger circuits.

2. The device according to claim 1, wherein a first terminal of the one second trigger circuit is connected to a t-th common terminal of the common terminals counted from the first electrode terminal to the second electrode terminal, and 2≤t≤n−1, wherein t is an integer.

3. The device according to claim 2, wherein
if a number n of the n gap units is 16 to 22, n−7≤t≤n−4;
if the number n of the n gap units is 13 to 15, n−6≤t≤n−2;
if the number n of the n gap units is 8 to 12, n−5≤t≤n−2;
if the number n of the n gap units is 4 to 7, n−2≤t≤n−1; and
if the number n of the n gap units is 3, t=2.

4. (canceled)

5. The device according to claim 1, wherein an i-th first trigger circuit of the k first trigger circuits connected to an i-th common terminal of the common terminals is defined as CXi, 1≤i≤t−1, wherein i is an integer, and a capacity of a capacitor in CXi is greater than or equal to a capacity of a capacitor in each of other first trigger circuits of the k first trigger circuits.

6. The device according to claim 5, wherein
if a number n of the n gap units is 16 to 22, 5≤t−i≤10;
if the number n of then gap units is 13 to 15, 4≤t−i≤9;
if the number n of the n gap units is 8 to 12, 3≤t−i≤6;
if the number n of then gap units is 4 to 7, 2≤t−i≤3; and
if the number n of the n gap units is 3, t−i=1.

7. The device according to claim 5, wherein a spark gap spacing of each of 2nd to i-th gap units of the n gap units counted from the first electrode terminal to the second electrode terminal is less than or equal to a spark gap spacing of each of other gap units of then gap units.

8. The device according to claim 1, wherein a spark gap spacing of a first gap unit of the n gap units adjacent to the first electrode terminal is greater than or equal to a spark gap spacing of each of other gap units of the n gap units.

9. The device according to claim 1, wherein the first terminals of the k first trigger circuits and the first terminal of the second trigger circuit are connected to n−1 common terminals of the common terminals sequentially and alternately from the first electrode terminal to the second electrode terminal.

10. The device according to claim 1, wherein a voltage limiting circuit is connected between the first electrode terminal and the second electrode terminal, and the voltage limiting circuit comprises a voltage limiting element or a combination of the voltage limiting element and a switching element.

11. The device according to claim 1, wherein each of the k first trigger circuits and the second trigger circuit each comprise only a capacitor or comprise a capacitor in combination with one or more of a capacitor, resistor, varistor, inductor, thermistor, transient suppression diode, air gap, and/or gas discharge tube (GDT).

12. The device according to claim 1, wherein the n gap units each comprise one of or a combination of at least two of GDTs, gaps formed by graphite electrodes, and gaps formed by metal electrodes; or the n gap units each comprise a combination of the GDTs, the gaps formed by the graphite electrodes, the gaps formed by the metal electrodes with at least one of capacitors, resistors, varistors, inductors, and thermistors.

13. A surge protective device, comprising:
a first electrode terminal and a second electrode terminal;
n gap units, wherein the n gap units are connected in series between the first electrode terminal and the second electrode terminal sequentially, wherein a common terminal is formed between adjacent gap units of the n gap units;
k first trigger circuits, wherein the k first trigger circuits each comprise a first terminal connected to one of the common terminals, and a second terminal connected to the second electrode terminal; and
only one second trigger circuit, wherein the second trigger circuit comprises a first terminal connected to one of the common terminals, and a second terminal connected to the first electrode terminal, wherein
n≥2, and 1≤k≤n−1, wherein n, and k integers.
wherein each of the k first trigger circuits and the second trigger circuit comprise a capacitor, and a capacity in the capacitor of the second trigger circuit is greater than a capacity of each capacitor in each of the k first trigger circuits.

14. A surge protective device, comprising:
a first electrode terminal and a second electrode terminal;
n gap units, wherein the n gap units are connected in series between the first electrode terminal and the second electrode terminal sequentially, wherein a common terminal is formed between adjacent gap units of the n gap units;
k first trigger circuits, wherein the k first trigger circuits each comprise a first terminal connected to one of the common terminals, and a second terminal connected to the second electrode terminal; and
m second trigger circuits, wherein the m second trigger circuits each comprise a first terminal connected to one of the common terminals, and a second terminal connected to one of the common terminals or connected to a same common terminal of the common terminals, wherein
n≥2, 1k≤<n−1, and 1≤m≤n−1, wherein n, k, and m are integers,
wherein each of the k first trigger circuits and the m second trigger circuits comprise a capacitor, and a capacity in each capacitor of the m second trigger circuits is greater than a capacity of each capacitor in each of the k first trigger circuits.

15. The device according to claim 1, wherein the capacity of the capacitor in the second trigger circuit is a times the capacity of each capacitor in each first trigger circuit and where 2≤a≤100.

16. The device according to claim 2, wherein the capacity of each capacitor m each second trigger circuit is a times the capacity of each capacitor in each first trigger circuit and where a=n−t.
